(19) United States
(12) Patent Application Publication
(10) Pub. No.: US 2006/0191179 A1
(43) Pub. Date: Aug. 31, 2006

(54) Compact road sign display

(76) Inventors: Alejandro Brunell Gonzalez, Dallas, TX (US); Sergio Damian Amaya Gonzalez, Monterrey (MX)

Correspondence Address: GIFFORD, KRASS, GROH, SPRINKLE & CITKOWSKI, P.C, PO BOX 7021, TROY, MI, 48007-7021, US

(21) Appl. No.: 11/359,823

(22) Filed: Feb. 22, 2006

Related U.S. Application Data
(60) Provisional application No. 60/656,308, filed on Feb. 25, 2005.

(51) Int. Cl. G09F 13/04

(52) U.S. Cl. 40/572

(57) ABSTRACT

A display assembly includes a translucent signboard, a housing and a light source. The housing has a base, a cover and a pair of lateral covers fixedly secured to each other to define a rectangular opening for supporting the signboard therein. The light source is fixedly secured to an inner surface of one of the base, cover and lateral covers for illuminating the signboard. A method for manufacturing the housing includes the step of extruding frame members and cutting the frame members to length to form the base, cover, and lateral covers.

### CROSS REFERENCE TO RELATED APPLICATION

This application claims priority to U.S. Provisional Patent Application 60/656,308, which was filed on Feb. 25, 2005 and is hereby incorporated by reference in its entirety.

### BACKGROUND OF THE INVENTION

1. Field of the Invention

The invention relates to lighted street displays. More particularly, the invention relates to a lighted street display having extruded frame members and a method of making the same.

2. Description of the Related Art

It is known to illuminate road signs to permit viewing of the sign at night. One form of sign utilizes fluorescent tubes housed within a housing and the street name is printed on a sheet of plastic in a light color, such as white, contrasted against a dark background, such as green. The panels are mounted in the frame such that the fluorescent lights shine through both the background and the street name to permit reading. Typically, three or more fluorescent bulbs are mounted vertically between a pair of signboards. However, the sign housing must be wide enough to accommodate the bulbs. Such housings are typically seven inches or more at the base. It is also known to use LED displays instead of fluorescent bulbs. Each bulb is replaced with an LED bar having an array of LED displays. The housing is mounted on a horizontally extending pole; however, the way the fluorescent bars or LED bars were mounted made a relatively large, heavy housing. To ensure the correct light uniformity for the sign, the distance between the light bar and the signboard had a restricted distance that could not be reduced. This display must be suspended from a pole and be able to stand the forces of wind and rain from storms. Accordingly, it would be desirable to provide a light display which is smaller and lighter, yet provides good visibility of the street name.

### SUMMARY OF THE INVENTION

According to one aspect of the invention, a method is provided for manufacturing an illuminated display. The method includes the steps of: forming a base, a cover and a pair of side covers by extrusion; fixedly securing the base, cover and side covers together to form a housing with two open and opposite sides; fixedly securing a signboard to one of the open sides of the housing; and fixedly securing a light source along an inner surface of at least one of the base, cover or side covers for illuminating the signboard.

According to another aspect of the invention, a display assembly includes a translucent signboard, a housing and a light source. The housing has a base, a cover and a pair of lateral covers fixedly secured to each other to define a rectangular opening for supporting the signboard therein. The light source is fixedly secured to an inner surface of one of the base, cover and lateral covers for illuminating the signboard.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a perspective view of a lighted street display according to one embodiment of the invention;

FIG. 2 is a cross sectional view of the display in FIG. 1;

FIG. 3 is a cross sectional view of the display according to a second embodiment of the invention; and

FIG. 4 is a cross sectional view of a portion of the display according to a third embodiment of the invention.

### DETAILED DESCRIPTION OF THE INVENTION

The invention provides a novel housing assembly for a lighted street display or sign and a method of manufacturing the same. The housing utilizes a single LED light bar mounted along an inner surface of a side member. The housing is assembled using aluminum extrusions which permit rapid assembly of different sized housings from the extrusions. The housing is narrower and requires less power to operate than conventional street signs.

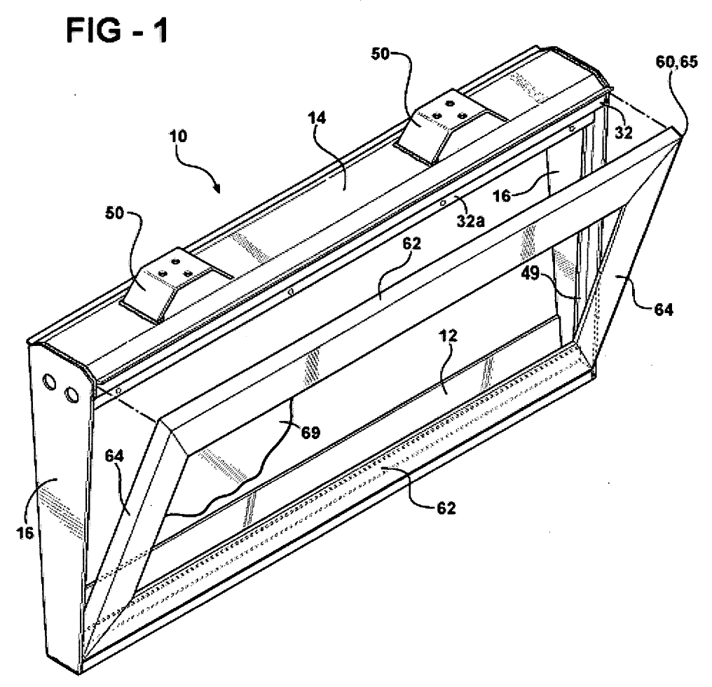

Referring to FIG. 1, the housing 10 includes a base 12, a cover 14 and a pair of sides or lateral covers 16. The base 12 and cover 14 are generally parallel and extend between the lateral covers 16 to define a pair of rectangular openings. One opening is for a signboard and the other is for a hinged signboard assembly 60 which is mounted in the opening by hinges to permit access to the interior of the housing.

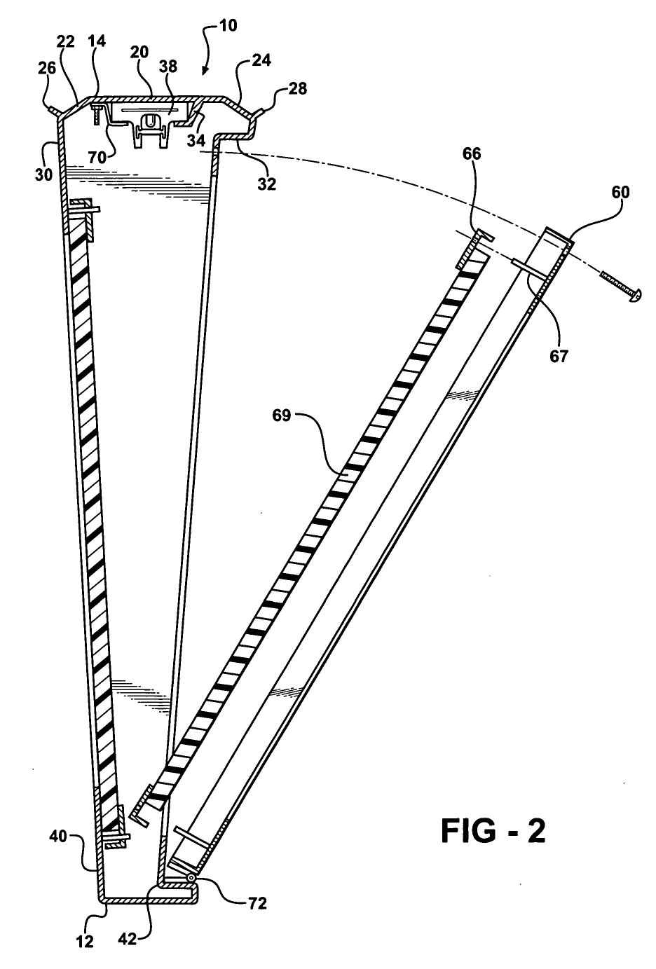

The base 12 and cover 14 are formed as extrusions and cut to necessary length. This permits manufacture of display assemblies having standard length, such as three, four, five or eight feet. As shown in FIG. 2, the cover 14 has an extruded cross section defined by a flat center portion 20 extending between a pair of downwardly angled portions 22, 24. A flange or drip rail 26, 28 protrudes upwardly and outwardly from a lower edge of each angled portion 22, 24 for catching rain. A straight wall 30 extends downwardly on one side to define the upper side of the opening for receiving the signboard on the non-opening side of the housing 10. A stepped wall 32 is formed on the other side to define the opening for the hinged signboard assembly 60. The stepped wall 32 is recessed or spaced apart from a leading edge of the lateral covers 16, so that the signboard 69 or signboard assemblies 60 are substantially flush with the housing 10. An integral bent arm 34 extends from an inner surface 36 of the cover 14 for mounting the LED bar 38. As shown in FIG. 2, the base 12 has an extruded cross section defined by a substantially vertical wall 40 on one side and a stepped wall 42 on the opposite side. The stepped wall 42 of the base 12 is generally mirror opposite to the stepped wall 32 of the cover 14 for defining the opening for the hinged signboard assembly 60.

The lateral covers 16 are tapered from the top to the bottom, so that the signboards when mounted in the openings will be angled downwardly toward the oncoming traffic. The lateral covers 16 have flanges for joining the walls of the cover 14 and base 12 to define the openings. Each lateral cover 16 includes holes or perforations for mounting a power source and assembly adaptors. A support wall 49 is fixedly secured to an inner surface of each lateral cover 16. The support wall 49 is aligned with a downwardly extending portion 32a of the stepped wall 32. The support wall 49 together with the downwardly extending portion 32a of the stepped wall provide a surface for supporting periphery of the signboard assembly 60. As discussed below, the ends of the cover 14, base 12 and lateral covers 16 are welded together to form a housing with open sides for mounting of the signboard assembly 60 on one side and a signboard on the other.

A pair of handles 50 are mounted to the top of the cover 14 or to the side surface of the lateral covers 16 for attachment to rods which support the display on a structure.

Referring to FIGS. 1 and 2, the signboard assembly 60 includes top and bottom frame members 62 and side frame members 64, each having an extruded generally L-shaped cross section. The ends of the frame members 62, 64 are cut at 45 degrees and welded together to form a rectangular framework 65 with an aperture for displaying the display board 62. The signboards are attached to the framework 65 with extruded L-shaped holders 66. The holders 66 are press fit onto studs 67 extending outwardly from the back of the framework 65 to press the signboard 69 against a peripheral gasket and the framework.

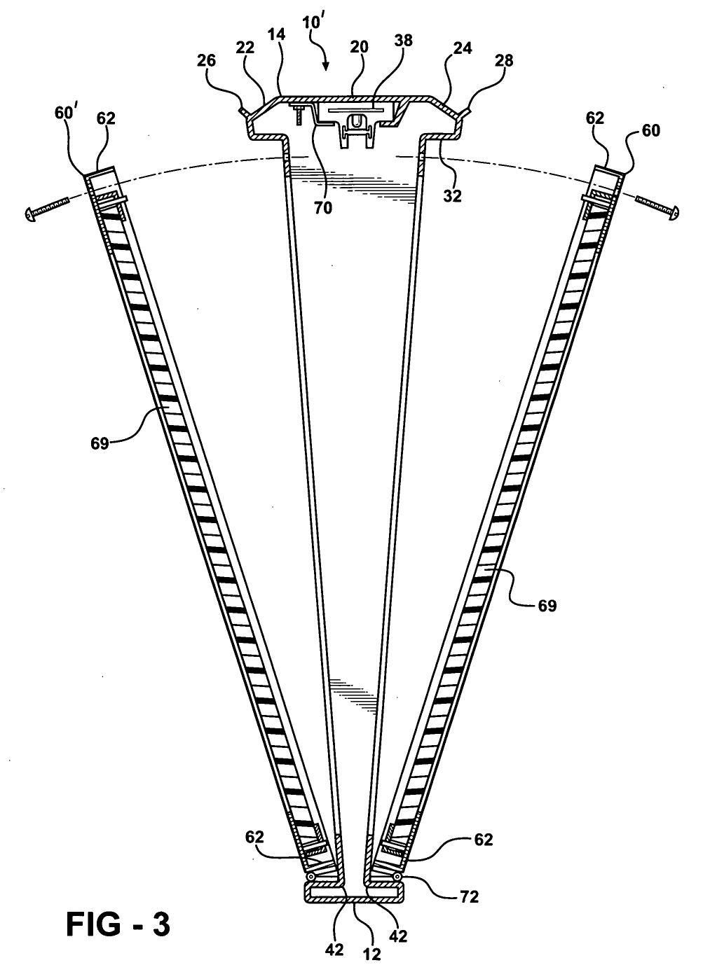

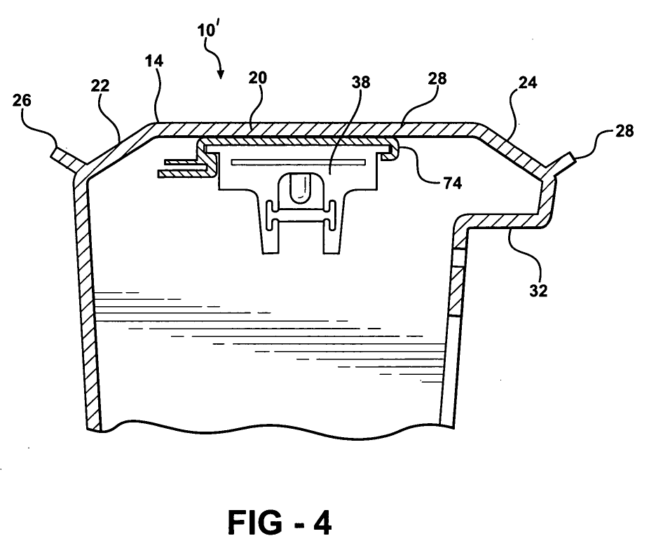

In one embodiment of the invention, the interior of the housing 10 is finished with a light color, such as white, to enhance the reflection light emitted from the LED light bar 38 and to ensure a generally even illumination of the signboard or signboard assembly 60. One side of the light bar 38 is retained against the inner surface 36 of the cover 14 by the bent arm 34. An L-shaped mounting bracket 70 is screwed or bolted to the cover 14 to retain the opposite side of the light bar 38 along the inner surface 36 of the cover 14. Optionally, as shown in FIG. 4, a one-piece spring metal clip 74 is fixedly secured to the center portion 20 of the cover 14 for supporting the light bar 38. The light bar 38 includes an array of LED displays that are spaced apart along the bar 38. Suitable LED bars are made by Leotek of California. A power source for converting electrical energy to the proper voltage for the LEDs is mounted on the interior of one of the lateral covers 16. The signboard assemblies 60 are mounted to the stepped wall 42 of the base 12 with hinges 72 so that the interior of the housing 10 can be accessed. Optionally, the signboard assemblies 60 may be hingedly mounted to the stepped wall 32 of the cover 14, or to stepped walls or similar flanges formed on the lateral covers 16. Optionally, as shown in FIG. 3, the housing 10′ may also have signboard assemblies 60, 60′ or signboards in both openings. In the event that the one side of the housing is not visible to traffic, a non-translucent panel may be mounted in the opening and painted black to match the housing 10.

### Method of Manufacture

The method of manufacture includes the steps of forming the base 12, cover 14, framework pieces 62, 64 and signboard holders 66 by extrusion. The extrusions are cut to length to form standard length housings. The side covers 16 and skin are stamped. The bottom ends of the lateral covers 16 are welded to the base 12 and the top ends are welded to the cover 14, thereby forming a housing 10 with two open sides. AS best shown in FIG. 1, handles 50 for mounting the housing 10 to the structure are welded onto the top or to the side.

The signboard assembly 60 is formed by cutting the ends of L shaped aluminum framework extrusions 62, 64 at a 45-degree angle. The ends are welded to form a rectangular shaped framework 65. The housing 10 and framework 65 are finished outside with a combining color and inside with a light color.

The LED bar 38 is mounted to the arm 34 on the inner surface of the cover 14 with holders and the power source is mounted to the inner surface of a lateral cover 16 by screws. A strip of gasket is adhered to the inner surface along the four sides of the opening. The signboard assembly 60 is then mounted to the base 12 with hinges 72 to permit the assembly 60 to pivot forwardly and downwardly to access the inner components. It is readily appreciated that the signboard assembly 60 may also be assembled to the housing 10 using other suitable methods, such as screwing, bolting, welding and the like.

The signboards 69 are formed of white translucent sheets with mechanical and light transmission properties similar to polycarbonate. The street name or other word or logo is trimmed inverse and placed in a translucent or transparent colored film sheeting. The signboards 69 are mounted in the opening of the framework 65 and opening in the housing 10 with the L-shaped holder pieces 66. Bosses or studs 67 are pressed in the housing 10 and framework 65 and the holders 66 are pressed onto the studs 67.

Thus is provided a lightweight street sign assembly 10 having low power consumption which is easily mounted. An LED bar 38 is mounted in the center of the cover 14. The LED requires much less space and thus the size of the housing can be greatly reduced. The light color finish of the interior combined with a narrow housing profile permits use of a LED array on the bar 38 to provide a consistent light intensity fully across the street sign. The street sign assembly according to one embodiment of the invention has a width of about 2 inches at the bottom and about 5.8 inches at the top. This is compared with a width of about 7 inches at the bottom and about 11 inches at the top of the prior art devices. Thus, the weight of the new display is approximately half the weight of the prior art devices.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A method of manufacturing an illuminated display, the method comprising the steps of:
forming a base, a cover and a pair of side covers by extrusion;
fixedly securing the base, cover and side covers together to form a housing with two open and opposite sides;
fixedly securing a signboard to one of the open sides of the housing; and
fixedly securing a light source along an inner surface of at least one of the base, cover or side covers for illuminating the signboard.

2. The method as set forth in claim 1 including the step of finishing the inside of the housing in a light color so as to promote even illumination of the signboard.

3. The method as set forth in claim 1 including the step of hingedly mounting the signboard to the housing to allow selective access to the inside of the housing.

4. The method as set forth in claim 3 including the step of:
forming frame members from an extrusion having a generally L-shape;
cutting the ends of the frame members at a 45-degree angle; and
fixedly securing the ends of the frame members together to form a framework for supporting the signboard.

5. The method as set forth in claim 4 including the step of hingedly coupling one of the frame members of the framework to the housing.

6. The method as set forth in claim 1 including the step of providing a light source in the form of a LED bar;

7. The method as set forth in claim 6 including the step of mounting the LED bar along an inner surface of the cover.

8. A display assembly comprising:
a translucent signboard;
a housing having a base, a cover and a pair of lateral covers fixedly secured to each other to define a rectangular opening for supporting the signboard therein; and
a light source fixedly secured to an inner surface of one of the base, cover and lateral covers for illuminating the signboard.

9. The display assembly as set forth in claim 8 including a framework for supporting the signboard, the framework being formed from frame members having a substantially L-shaped extruded cross section.

10. The display assembly as set forth in claim 9, wherein the framework is hingedly coupled to the base to allow selective access to an interior portion of the housing.

11. The display assembly as set forth in claim 8, wherein the housing includes a pair of openings for supporting a pair of signboards.

12. The display assembly as set forth in claim 11 including a pair of frameworks for supporting the signboards in respective openings of the housing.

13. The display assembly as set forth in claim 12, wherein at least one of the frameworks is hingedly coupled to the base to allow selective access to an interior portion of the housing.

14. The display assembly as set forth in claim 8, wherein the base has an extruded cross section defined by a substantially flat center portion extending between a pair of downwardly angled portions.

15. The display assembly as set forth in claim 14, wherein the base includes a drip rail extending outwardly from a lower edge of each angled portion.

16. The display as set forth in claim 9, wherein the base has an extruded cross section having a stepped wall for supporting a side of the framework.

17. The display as set forth in claim 16, wherein the stepped wall includes a downwardly extending portion spaced apart from a leading edge of each lateral cover for supporting a side of the framework.

18. The display as set forth in claim 17 including a support wall extending from an inner surface of each lateral covers, the support walls being aligned with the downwardly extending portion of the stepped wall to provide a surface for supporting the framework in a flush manner with the leading edges of the lateral covers.

19. The display as set forth in claim 17, wherein the light source is provided in the form of an array of LEDs.
